(19) United States
(12) Patent Application Publication
(10) Pub. No.: US 2008/0139121 A1
(43) Pub. Date: Jun. 12, 2008

(54) Communication device for connecting a blue tooth handset to an indoor phone

(76) Inventors: Ching Yuan Wang, Taoyuan Hsien (TW); Ching Huang Wang, Taoyuan Hsien (TW)

Correspondence Address: Ching Yuan Wang, 235 Chung-Ho, Box 8-24, Taipei, omitted

(21) Appl. No.: 11/636,115

(22) Filed: Dec. 11, 2006

(51) Int. Cl. H04B 7/00

(52) U.S. Cl. 455/41.3

(57) ABSTRACT

A communication device for connecting a blue tooth handset to an indoor phone comprises a blue tooth handset being a wireless mobile handset and having a blue tooth transmission module; an indoor phone connected to a wired phone system; an integrating device arranged to a front end of a phone wire of the indoor phone, namely, between the phone wire and the indoor phone; the integrating device having a blue tooth transmission module which can be wirelessly transmitted to the blue tooth handset after matching the blue tooth specification; and the communication of the blue tooth handset can be converted to the indoor phone through the integrating device. The incoming phone call to the mobile phone can be transferred to the indoor phone, while the incoming phone call to the indoor phone still receives by the indoor phone without lose. Furthermore, the indoor phone can know that the mobile phone has entered the searching range so as to be connected thereto.

### FIELD OF THE INVENTION

The present invention relates to a communication device for connecting a blue tooth handset to an indoor phone, wherein the incoming phone call to the mobile phone can be transferred to the indoor phone without paying the fees to a phone company, while the incoming phone call to the indoor phone still receives by the indoor phone without lose. Thereby the switching between the mobile phone and the indoor phone is positioned automatically.

Furthermore, in the present invention, the indoor phone can know that the mobile phone has entered the searching range so as to be connected thereto.

### BACKGROUND OF THE INVENTION

Due to the improvement of electronic communication, mobile phones have become a necessary device in daily lift. Currently, advance of wireless transmission technology causes that most of mobile phones or electronic devices are equipped with blue tooth modules for wireless transmission.

Other than mobile phones, indoor phones are another communication devices. Often indoors, the rings of mobile phones are not heard due to being placed at a farther place. Thus some incoming calls are not received.

It is often that in office or home, there are some extension lines being equipped which are connected to the wired phone system. Thus, if the mobile phone can be connected to the indoor phones, then most of the calls to the mobile phone can be received. Conventionally, the mobile phone can be set to transfer incoming call to the indoor phone. However in this way, the fees of transferring the call must be paid by users. Thus it is not economic.

### SUMMARY OF THE INVENTION

Accordingly, the primary object of the present invention is to provide a communication device for connecting a blue tooth handset to an indoor phone, wherein the incoming phone call to the mobile phone can be transferred to the indoor phone without paying the fees to phone company, while the incoming phone call to the indoor phone still receives by the indoor phone without lose. Thereby the switching between the mobile phone and the indoor phone is positioned automatically.

Furthermore, in the present invention, the indoor phone can know that the mobile phone has entered the searching range so as to be connected thereto.

To achieve above objects, the present invention provides a communication device for connecting a blue tooth handset to an indoor phone comprising: a blue tooth handset being a wireless mobile handset and having a blue tooth transmission module; an indoor phone connected to a wired phone system; and an integrating device arranged to a front end of a phone wire of the indoor phone, namely, between the phone wire and the indoor phone; the integrating device having a blue tooth transmission module which can be wirelessly transmitted to the blue tooth handset after matching the blue tooth specification; and the communication of the blue tooth handset can be converted to the indoor phone through the integrating device.

The various objects and advantages of the present invention will be more readily understood from the following detailed description when read in conjunction with the appended drawing.

### BRIEF DESCRIPTION OF THE DRAWINGS

FIG. 1 is a schematic view showing the arrangement of the present invention.

FIG. 2 is a circuit block diagram of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

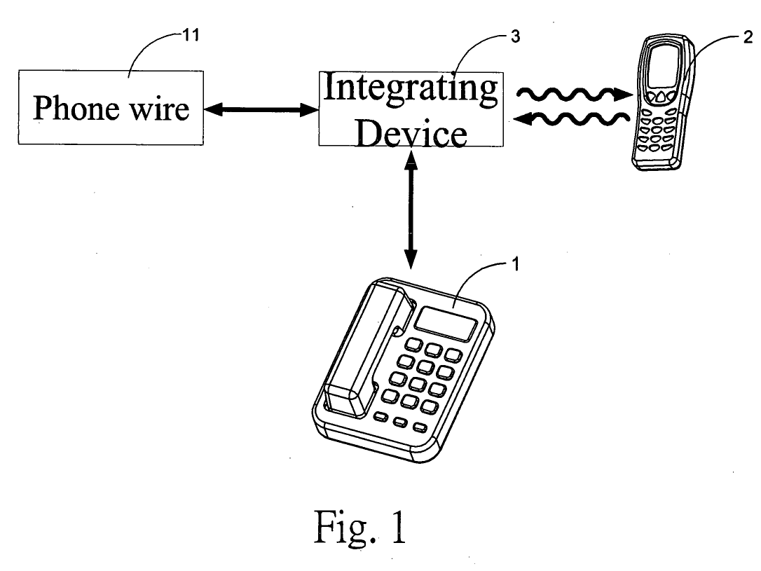

Referring to FIG. 1, the communication device for connecting a blue tooth handset to an indoor phone of the present invention is illustrated. In the present invention, an integrating device 3 with wireless blue tooth transmission and receiving functions is assembled to a front end of a wire of an indoor phone 1. This is, the integrating device 3 is used to connect the indoor phone 1 with a blue tooth handset 2 between a front end of a phone wire 11 of a wired phone and the indoor phone 1.

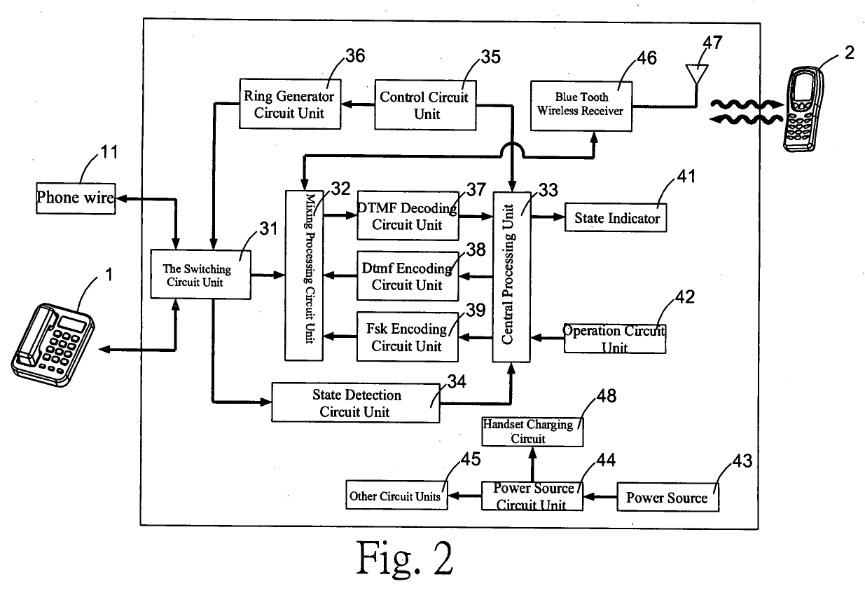

With referring to FIG. 2, the integrating device 3 has the following elements.

A switching circuit unit 31 is connected between a phone wire 11 and an indoor phone 1 for switching the indoor phone 1 to be connected to a phone wire 11 of a wired phone or to a blue tooth handset 2 as a communication source.

A mixing processing circuit unit 32 is a multiplexing processor for processing electronic signals. The mixing processing circuit unit 32 is connected to the switching circuit unit 31, a blue tooth wireless receiver 46, a DTMF decoding circuit unit 37, a DTMF encoding circuit unit 38, and a FSK encoding circuit unit 39.

A central processing unit 33 (a CPU) serves for processing, setting and operating the electronic signals and data of all circuits. The periphery of the central processing unit 33 is connected to a state detection circuit unit 34, a voltage control circuit unit 35, the DTMF decoding circuit unit 37, the DTMF encoding circuit unit 38, the FSK encoding circuit unit 39, a state indicator 41 and an operation circuit unit 42.

The state detection circuit unit 34 serves for detecting the communication related state and responds to the central processing unit 33.

The voltage control circuit unit 35 serves for processing and control voltage for driving a ring generator circuit unit 36.

The ring generator circuit unit 36 is controlled by the voltage control circuit unit 35 so as to drive the indoor phone 1 to ring for calling an user.

The DTMF decoding circuit unit 37 serves to decode the DTMF (dual tone multiple frequency) signals. The DTMF encoding circuit unit 38 serves to encode DTMF signals. The FSK encoding circuit unit 39 serves to encode the FSK (frequency shift keying) signals.

The state indicator 41 serves for display data on the casing of the integrating device 3 so that the user can understand the operation state to match with the blue tooth signals.

The operation circuit unit 42 serves for being operated and setting by users.

A power source 43 and a power source circuit unit 44 provide electric power to the integrating device 3 and to other circuit units 45.

The blue tooth wireless receiver 46 serves for providing wireless transmission function to the integrating device 3 so as to be connected to the blue tooth handset 2 through an antenna 47.

When the user installs the integrating device 3 of the present invention, the user must match the blue tooth handset 2 to the integrating device 3 so as to suit the blue tooth specification. Then, if the blue tooth handset 2 is out of transmission range, the blue tooth handset 2 is released from the integrating device 3. Then the indoor phone 1 is only connected to the phone wire 11 of the wire phone system.

When the blue tooth handset 2 enters into the transmission range of the integrating device 3, then the integrating device 3 will detect the existence of the blue tooth handset 2 and is connected thereto. Then, if a phone call is from the wire phone system, the switching circuit unit 31 will switch the phone wire 11 to the indoor phone 1. The user can receive signals from the wired phone system. If the call enters into the blue tooth handset 2, the signals are received through the antenna 47 and the blue tooth wireless receiver 46. Then the signals are transferred to the mixing processing circuit unit 32, central processing unit 33, and voltage control circuit unit 35 so that the ring generator circuit unit 36 generates ring signals and the switching circuit unit 31 will temporarily cut off the connection to the phone wire 11. The incoming call of the blue tooth handset 2 will be transferred to the indoor phone 1 through the integrating device 3 and generates ring sounds. If the indoor phone 1 has the function of displaying phone numbers of the incoming calls, then the phone numbers are displayed on the display screen of the indoor phone 1. Thereby the user can receive the incoming phone calls of the blue tooth handset 2 through the indoor phone 1.

If the user desires to dial out through the indoor phone 1, the user can select to use the phone wire 11 or the blue tooth handset 2, for example to press a preset simplifying codes (such as a * key) so that the call can be outputted from the phone wire 11.

Thus, in the present invention, even the phone wire 11 can not work normally or the user do not register to the wired phone system, the user can output a call from the indoor phone 1 and then to emit the call through the blue tooth handset 2.

The above mentioned integrating device 3, further comprises a handset charging circuit 48 which is connected to the power source circuit unit 47 and is connected to the blue tooth handset 2 through USP plug or the plugs.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A communication device for connecting a blue tooth handset to an indoor phone comprising:
a blue tooth handset being a wireless mobile handset and having a blue tooth transmission module;
an indoor phone connected to a wired phone system;
an integrating device arranged to a front end of a phone wire of the indoor phone, namely, between the phone wire and the indoor phone; the integrating device having a blue tooth transmission module which can be wirelessly transmitted to the blue tooth handset after matching the blue tooth specification; and the communication of the blue tooth handset can be converted to the indoor phone through the integrating device.

2. The communication device for connecting a blue tooth handset to an indoor phone as claimed in claim 1, wherein the integrating device is built within the indoor phone.

3. The communication device for connecting a blue tooth handset to an indoor phone as claimed in claim 1, wherein the integrating device further comprises:
a switching circuit unit connected between the phone wire and an indoor phone for switching the indoor phone to be connected to a phone wire of a wired phone or to a blue tooth handset as a communication source;
a mixing processing circuit unit being a multiplexing processor for processing electronic signals;
a central processing unit (a CPU) for processing, setting and operating the electronic signals and data of all circuits;
a state detection circuit unit for detecting the communication related state and responds to the central processing unit;
a voltage control circuit unit for processing and control voltage to drive a ring generator circuit unit;
the ring generator circuit unit controlled by the voltage control circuit unit so as to drive the indoor phone to ring for calling an user;
an operation circuit unit for being operated and setting by users;
a power source and a power source circuit unit providing electric power to the integrating device and to other circuit units;
a blue tooth wireless receiver for providing wireless transmission function to the integrating device so as to be connected to the blue tooth handset through an antenna.

4. The communication device for connecting a blue tooth handset to an indoor phone as claimed in claim 1, wherein the mixing processing circuit unit is connected to a switching circuit unit, a blue tooth wireless receiver, a DTMF decoding circuit unit, a DTMF encoding circuit unit and an FSK encoding circuit unit.

5. The communication device for connecting a blue tooth handset to an indoor phone as claimed in claim 1, wherein the central processing unit is connected to a switching circuit unit, a voltage control circuit unit, a DTMF decoding circuit unit, a DTMF encoding circuit unit, a FSK encoding circuit unit, a state detection circuit unit, and an operation circuit unit.

6. The communication device for connecting a blue tooth handset to an indoor phone as claimed in claim 4, wherein
the DTMF decoding circuit unit serving for decoding the DTMF (dual tone multiple frequency) signals;
the DTMF encoding circuit unit serving for encoding DTMF signals; and
the FSK encoding circuit unit serving for encoding FSK (frequency shift keying) signals;
wherein a phone number of the incoming call is displayed.

7. The communication device for connecting a blue tooth handset to an indoor phone as claimed in claim 5, wherein
the DTMF decoding circuit unit serving for decoding the DTMF signals;
the DTMF encoding circuit unit serving for encoding DTMF signals; and
the FSK encoding circuit unit serving for encoding FSK signals;
wherein a phone number of the incoming call is displayed.

8. The communication device for connecting a blue tooth handset to an indoor phone as claimed in claim 1, wherein the integrating device further comprises a state indicator for displaying data on the casing of the integrating device so that the user can know the matching state about blue tooth.

9. The communication device for connecting a blue tooth handset to an indoor phone as claimed in claim 3, wherein the integrating device further comprises a handset charging circuit which is connected to the power source circuit unit and is connected to the blue tooth handset through USP plug or the plugs.
